(19) United States
(12) Patent Application Publication
(10) Pub. No.: US 2003/0052120 A1
(43) Pub. Date: Mar. 20, 2003

(54) Electric blanket control system

(76) Inventors: Mark William Zabrowsky, Boca Raton, FL (US); Augusto Picozza, Boca Raton, FL (US); Robert Bloxsom, Petal, MS (US); Scott Duplantis, Hattiesburg, MS (US)

Correspondence Address: Kramer Levin Naftalis & Frankel LLP, 919 THIRD AVENUE, NEW YORK, NY, 10022, US

(21) Appl. No.: 10/261,647

(22) Filed: Oct. 1, 2002

Related U.S. Application Data
(63) Continuation of application No. 09/675,519, filed on Sep. 29, 2000, now abandoned.

(51) Int. Cl. H05B 1/02; H05B 3/00

(52) U.S. Cl. 219/501; 219/506; 219/212

(57) ABSTRACT

An electric blanket remote control system according to the present invention includes a remote control device and a base unit. The remote control device includes a case, a digital display, an RF transmitter, electronic circuitry, a microprocessor and a power supply connection. The base unit may include a container, an RF receiver, a variable current control circuit, a safety detection circuit, blanket connection circuitry, electronic circuitry, a microprocessor, and power supply connection circuitry. The remote control device transmits command controls to the base unit, and the base unit modulates an electric current flowing through the electric blanket in accordance with the command controls.

### FIELD OF THE INVENTION

The present invention relates to electric blanket control devices, and more specifically to a digital, RF-signal, electric blanket remote control system.

### BACKGROUND INFORMATION

The fundamental aspects of electric blankets are well-known in the art. An electric blanket generates heat as electricity passes through the resistive wiring integral to the blanket. The amount of heat generated depends on many factors, but two primary variables are the amount of electricity allowed to flow through the blanket, affecting the intensity of the heat, and its duration. Typically, a control device is used to regulate the intensity and duration of heat generated. The duration of heat generation generally is dependent on the time during which the blanket is turned on.

A simple ON/OFF power switch is a basic control device, in that a presumably fixed amount of electricity passes through the blanket while the control device is in the ON state, generating a relatively constant intensity of heat. Apart from residual heat dissipation, no heat is generated in the OFF state. More sophisticated control devices have used timers to alternate between the ON and OFF states, effectively regulating relative heat generation by controlling the duration of heat generation, without altering the amount of electricity passing through the blanket while in the ON state.

Another means of controlling the relative heat generation while the blanket is turned on is to marginally adjust the flow of electricity within the blanket through the use of a variable flow control, analogous to a dimmer switch. Increments of electric current adjustment may be coarse, such as with control settings of Low and High, or relatively fine, such as with settings of 1 to 10, with 1 corresponding to the lowest intensity of heat and 10 corresponding to the highest intensity of heat. Relative heat generation in this context is dependent on electric energy consumption, independent of the ambient temperature near the blanket.

Electric blanket control devices may also regulate heat generation by means of a thermostat in conjunction with a variable current control device. Whereas a simple variable current control device operating by itself may maintain a constant electric flow in the blanket, a thermostat may use a variable current control to maintain a constant blanket temperature by varying the electric flow in the blanket. Ambient temperatures around the blanket will affect the blanket temperature as heat is exchanged between them. As ambient temperatures rise or fall, the thermostat may decrease or increase, respectively, the flow of electricity to the blanket to maintain a desired temperature.

Remote control systems are also well-known in the art. Two popular methods of remote control involve infrared (IR) signals and radio frequency (RF) signals. Infrared signals are easily absorbed by objects in their path, so IR remote control devices require a direct, unobstructed line-of-sight between the IR remote control device and the base IR receiver. Most television remote control systems, for example, use IR remote control devices.

Remote control systems that do not use IR signaling typically may use other RF signals that are not easily absorbed by objects in their path. RF remote control devices generally do not require a direct, unobstructed line-of-sight between the RF remote control and the base RF receiver. Therefore, an RF remote control may be operated to control a base unit from almost any location within the effective range of the RF transmission. The effective range of the RF transmission will depend largely on the strength and frequency of the signal. Garage door openers, for example, typically use RF remote control systems.

Digital displays are also well-known in the art. A digital display typically may use either a liquid crystal display (LCD) or a light-emitting diode (LED) display. A common digital sports watch, for example, uses a digital display having an LCD to display such data as the time, the date, an alarm, and a stopwatch. Similarly, a common digital microwave oven display, for example, uses an LED display, so that it may be read in little or no light, to display such data as the time, the cooking intensity, and possibly the temperature of the food.

Therefore, it would be advantageous to design an electric blanket control system that incorporates many of the benefits of previous electric blanket control devices in a remote control system using RF signaling and having a user-friendly, digital display.

### SUMMARY OF THE INVENTION

The present invention relates to electric blanket control devices, and more specifically to a digital, RF-signal, electric blanket remote control system. An electric blanket remote control system according to the present invention may include a remote control device and a base unit. The remote control device may include a case, a digital display, an RF transceiver, electronic circuitry, a thermostat, a microprocessor and a battery power supply connection. The base unit may include a container, an RF transceiver, a variable current control circuit, a safety detection circuit, blanket connection circuitry, electronic circuitry, a microprocessor, and power supply connection circuitry.

### BRIEF DESCRIPTION OF THE DRAWINGS

FIGS. 1A-1B show block diagrams of an electric blanket remote control device and an electric blanket base unit, respectively, according to exemplary embodiments of the present invention.

FIG. 2 shows a perspective view of an electric blanket remote control device according to an exemplary embodiment of the present invention.

FIG. 3 shows a plan view of the electric blanket remote control device of FIG. 2.

FIG. 4 shows a perspective view of an electric blanket base unit according to an exemplary embodiment of the present invention.

Other features and advantages of the present invention will be apparent from the following description of the exemplary embodiments thereof, and from the claims.

### DETAILED DESCRIPTION

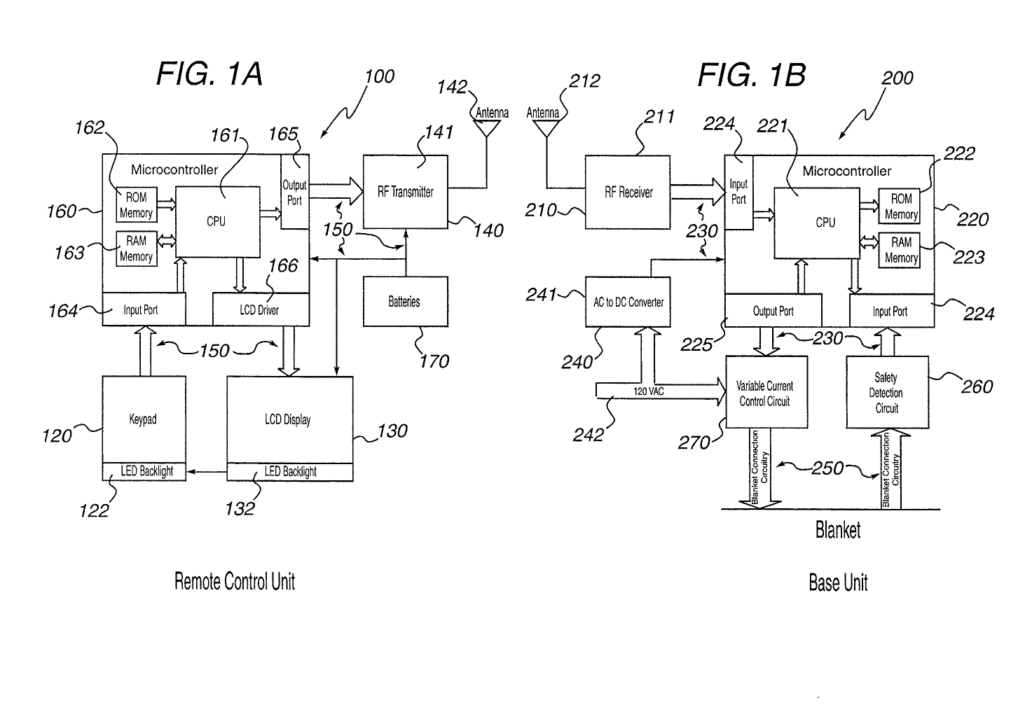

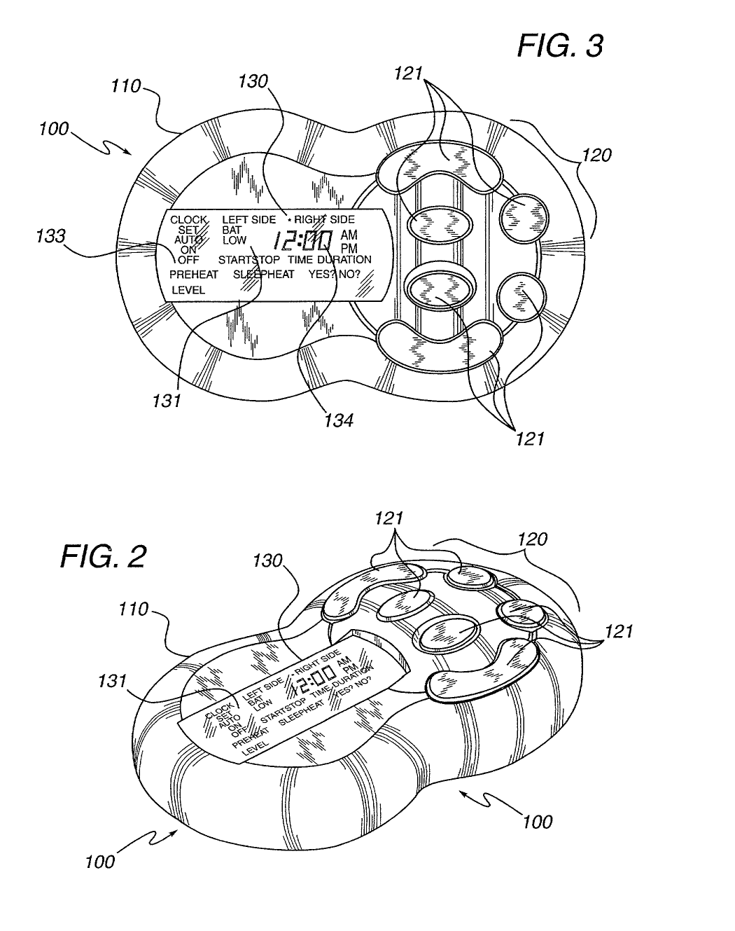

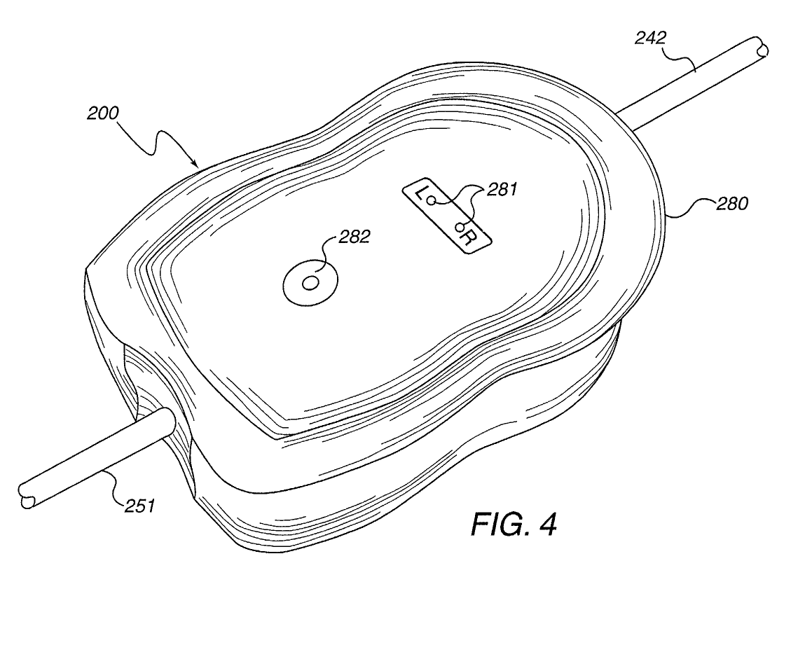

An electric blanket remote control system 1 according to the present invention may include a remote control device 100 and a base unit 200. Referring to FIGS. 1A-1B, FIG. 1A shows a block diagram of an electric blanket remote control device 100 according to an exemplary embodiment of the present invention. The remote control device 100 may include a case 110 (shown in FIGS. 2 and 3), a keypad 120, a digital display 130, an RF interface assembly 140, electronic circuitry 150, a microcontroller 160 and a power supply 170.

As shown in FIG. 1A, the microcontroller 160 may be coupled to each of the keypad 120, the digital display 130, the RF interface assembly 140, and the power supply 170. The microcontroller 160 may include, for example, a central processing unit (CPU) 161, read-only memory (ROM) 162, random-access memory (RAM) 163, an input port 164, an output port 165, and a display driver 166. Furthermore, the input port 164 interfaces the keypad 120 with the CPU 161, the output port interfaces the RF interface assembly 140 with the CPU 161, and the display driver 166 interfaces the digital display 130 with the CPU 161.

The keypad 120 may include an LED backlight 122. Likewise, the digital display 130 may include a LED backlight 132. The RF interface assembly 140 may include an RF transmitter 141 connected to an antenna 142. The power supply 170 may include, for example, a battery bay to hold 2 “AAA” sized batteries. Alternatively, the power supply 170 may include a rechargeable power cell that is recharged by a separate recharger assembly, which could be attached by a detachable recharger cord.

Although not shown in FIG. 1A, the remote control 100 also may include a thermostat 180 having a thermometer 181 with which remote control 100 measures the ambient temperature. The remote control 100 therefore may display the ambient temperature on the display 130. Furthermore, the system 1 may use the ambient temperature instead of the blanket temperature as a variable in adjusting the heat intensity level applied by the base unit 200. Thus, the thermostat 180 may compensate the blanket heat level for the ambient room temperature. First, the thermometer 181 may measure the ambient temperature, and second, the thermostat 180 may apply temperature compensation to the heat level commands sent to the base unit 200 to maintain constant blanket temperature as the ambient temperature varies. An algorithm 182 stored in the remote control 100 calculates how much to adjust the heat level relative to the ambient temperature to maintain a desired blanket temperature.

Likewise, the thermostat 180, thermometer 181, and the algorithm 182 may be located on the base unit 200 instead of on the remote control device 100, but this would require that the remote control device 100 be able to receive data transmitted by the base unit 200 in order for the display 130 of the remote control device 100 to show the ambient temperature measured at the base unit 200. Such a configuration would require the use of RF transceivers in both the remote control device 100 and base unit 200, as discussed in detail below. If RF transceivers are used, the thermometer 181 may be separated from the thermostat 180 and the algorithm 182, allowing for the ambient temperature data to be compiled at one place and transmitted to another place.

By comparison, FIG. 1B shows a block diagram of an electric blanket base unit 200 according to an exemplary embodiment of the present invention. The base unit 200 may include an RF interface assembly 210, a microcontroller 220, electronic circuitry 230, power supply connection circuitry 240, blanket connection circuitry 250, a safety detection circuit 260, a variable current control circuit 270 and a container 280 (shown in FIG. 4).

As shown in FIG. 1B, the microcontroller 220 may be coupled via the electronic circuitry 230 to each of the RF interface assembly 210, the power supply connection circuitry 240, the blanket connection circuitry 250, the safety detection circuit 260, and the variable current control circuit 270. The microcontroller 220 may include, for example, a central processing unit (CPU) 221, read-only memory (ROM) 222, random-access memory (RAM) 223, input ports 224, and an output port 225. Furthermore, the input ports 224 interface the RF interface assembly 210 and the safety detection circuit 260 with the CPU 221, and the output port 225 interfaces the variable control circuit 270 with the CPU 221.

The RF interface assembly 210 may include an RF receiver 211 connected to an antenna 212. The power supply connection circuitry 240 may include an alternating current-to-direct current (AC/DC) converter 241 and a power cord 242 (shown in FIG. 4) adapted to plug into a power outlet. The AC/DC converter 241 supplies a direct current to the microcontroller 220. The power supply connection circuitry 240 may provide 120V AC to the variable control circuit 270. The blanket connection circuitry 250 may include a blanket cord 251 (shown in FIG. 4) coupling the base unit 200 to the blanket. For easier disassembly and storage, power cord 242 and blanket cord 251 may attach and detach from the base unit 200, and blanket cord 251 may attach and detach from the blanket. The variable control circuit 270 interfaces the power supply with the blanket connection circuitry 250 and modulates the duty cycle of the power supplied to the blanket. The safety detection circuit 260 may monitor blanket sensors (not shown) or it may simply monitor the electrical feed-back from the power supplied by the variable control circuit 270. If for example the safety detection circuit 260 detects a drop in resistance that may indicate a local short circuit, the safety detection circuit 260 may instruct the microcontroller 220 to deactivate the blanket.

In the event that the remote control system 1 intends to have the remote control device 100 receive data transmitted from the base unit 200 as well as have the base unit 200 receive data transmitted from the remote control device 100, RF transmitter 141 of FIG. 1A and RF receiver 211 of FIG. 1B may be replaced with RF transceivers 143, 213 (not shown) coupled to both the input and output ports, respectively 164, 165 and 224, 225. The use of RF transceivers 143, 213 would permit the base unit 200 to communicate the status of the blanket to the remote control device 100.

For example, base unit 200 could inform the remote control device 100 that the blanket is not plugged in to the base unit 200, preventing the execution of any instructions received from the remote control device 100. Similarly, if a battery were coupled to the base unit 200, the base unit 200 would have power to inform the remote control 100 that the power supply connection 240 is not plugged into a power outlet. The base unit 200 could also relay intermediate status information to the remote control device 100. For example, the blanket may include a blanket thermometer coupled to the safety detection circuit 260, allowing the base unit 200 to transmit the current blanket temperature compared to the programmed blanket temperature. Similarly, the safety detection circuit 260 may measure the electrical resistance of the blanket, and the microcontroller 220 may calculate the current blanket temperature using a temperature algorithm dependent on the measured electrical resistance of the blanket relative to the electrical power supplied to the blanket.

FIGS. 2 and 3 respectively show a perspective view and a plan view of an electric blanket remote control device 100 according to an exemplary embodiment of the present invention. The case 110 may house the keypad 120, the digital display 130, the RF interface assembly 140 (shown in FIG. 1A), the electronic circuitry 150 (shown in FIG. 1A), the microcontroller 160 (shown in FIG. 1A) and the power supply 170 (shown in FIG. 1A). The keypad 120 may include buttons 121 and a keypad LED backlight 122 (shown in FIG. 1A) to illuminate the buttons 121. The display 130 may include a multifunctional, digital LCD 131 and a display LED backlight 132 (shown in FIG. 1A).

FIG. 4 shows a perspective view of an electric blanket base unit 200 according to an exemplary embodiment of the present invention. The container 280 may house the RF interface assembly 210 (shown in FIG. 1B), the microcontroller 220 (shown in FIG. 1B), electronic circuitry 230 (shown in FIG. 1B), the power supply connection circuitry 240, the blanket connection circuitry 250, the safety detection circuit 260 (shown in FIG. 1B), and the variable current control circuit 270 (shown in FIG. 1B).

The container 280 also may include one or more LED indicators 281 and a sound generator 282, both of which are coupled to microcontroller 220. In the event that the base unit 200 separately controls two blankets or two halves of one blanket, two LED indicators 281 may indicate the independent activation of each blanket or blanket half. The LED indicator 281 may luminesce when the associated electric blanket is activated. The sound generator 282 may beep or chirp to acknowledge reception of instructions from the remote control 100 or to sound an alarm signaled by the safety detection circuit 260. The sound generator 282 may comprise a loudspeaker, a piezoelectric element, or the like.

Given the intelligence of microcontrollers 160 and 220, the remote control system 1 may perform a wide variety of functions. Generally, each function will have an associated field on the digital display 130. The LCD 131 may have fixed fields 133 and variable fields 134 that are activated when the associated function is being programmed and displayed. For example, a preheat function may be displayed by a fixed field 133 to indicate that the preheat function is active or being programmed. Conversely, a clock function requires a variable field 134 to display the passage of time. As shown in FIGS. 2 and 3, an exemplary LCD 131 may display information regarding the status of up to two electric blankets (e.g., left and right), including among others the power status (On/Off/Auto), heating level, the time, heating times, and the heating duration.

As discussed, an electric blanket control device may employ several different methods to regulate the heating of the blanket. In conjunction with the microcontroller 160 of the remote control 100, the microcontroller 220 of the base unit 200 regulates the heating of a blanket coupled to the base unit 200. A user will input a desired heating regime into the remote control 100, and the remote control 100 programs the base unit 200 accordingly. The base unit 200 may regulate the heating of a blanket by varying start and stop times, the duration of the heating, the intensity level of the heat, and the desired temperature of the blanket.

By combining two or more of these variables, the base unit 200, for example, may preheat a blanket quickly to a desired temperature or level by applying the maximum heat for a short period until the desired status is reached and then reducing the heat to maintain the desired status. Similarly, the base unit 200 may be programmed to intermittently heat the blanket over a longer period, such as while a user sleeps. Intermittent ramping of heat may generate heat more efficiently with less excess, avoid overheating the blanket, and prolong the life of the blanket.

Note that while a remote control system 1 according to the present invention generally will be sold with one or two removably attached electric blankets, it may be feasible to use the system 1 with a different blanket, so long as the blanket is compatible with the power source connection 250 and the electrical output of the base unit 200. As is often the case, a power cord plugged into an electric blanket may be detachable from the blanket to facilitate laundering of the blanket. Accordingly, assuming a compatible match, an existing blanket control device may be unplugged from an existing blanket and replaced with the base unit 200 for use of the system 1 with the existing blanket.

A number of embodiments of the present invention have been described above. Nevertheless, it will be understood that various modifications may be made without departing from the spirit and scope of the invention. Accordingly, other embodiments are within the scope of the following claims. It is intended that all matter contained in the above description or shown in the accompanying drawings shall be interpreted as illustrative and not in a limiting sense. It is also understood that the following claims are intended to cover all of the generic and specific features of the invention herein described and all statements regarding the scope of the invention.

What is claimed is:

1. A remote control system of an electric blanket, the remote control system comprising:
a remote control device having a remote microcontroller; a keypad coupled to the remote microcontroller; a digital display coupled to the remote microcontroller; a remote power supply connection coupled to the remote microcontroller and electrically connectable to a remote power source; a remote RF transmitter coupled to the remote microcontroller; and a remote case housing the remote microcontroller, the keypad, the digital display, the remote power supply connection, and the remote RF transmitter; and
a base unit having a base microcontroller; a base power supply connection coupled to the base microcontroller and being electrically connectable via a power cord to a base power source; a blanket connection coupled to the microcontroller and being electrically connectable via a blanket cord to an electric blanket; a base RF receiver coupled to the base microcontroller; and a base container housing the base microcontroller, the base power supply connection, the blanket connection, and the base RF receiver;
wherein after a user connects the remote power supply connection to a remote power source, the base power supply connection to the base power source, and the blanket connection to the electric blanket, the user uses the keypad to generate primary command controls, the primary command controls are represented on the digital display and communicated to the remote microcontroller, the remote microcontroller interfaces the primary command controls with the remote RF transmitter, the remote RE transmitter transmits the primary command controls to the base RF receiver, the base RF receiver interfaces the primary command controls with the base microcontroller, and the base microcontroller modulates an electric current flowing through the blanket connection to the electric blanket in accordance with the primary command controls received from the remote control device.

2. The remote control system of claim 1, the remote control device further comprising a remote thermometer coupled to the remote microcontroller and housed in the remote case, and the remote microcontroller including an adjustment algorithm;
wherein the remote thermometer measures a remote ambient temperature proximate to the remote control device, the remote microcontroller calculates an adjustment command control based on the adjustment algorithm in light of the remote ambient temperature and the primary command controls, the remote microcontroller communicates the adjustment command control to the base microcontroller, and the base microcontroller modulates the electric current flowing through the blanket connection to the electric blanket in accordance with the adjustment command control in light of the primary command controls.

3. The remote control system of claim 1, the base unit further comprising a base thermometer coupled to the base microcontroller, and the base microcontroller including an adjustment algorithm;
wherein the base thermometer measures a base ambient temperature proximate to the base unit, the base microcontroller calculates an adjustment command control based on the adjustment algorithm in light of the base ambient temperature and the primary command controls, and the base microcontroller modulates the electric current flowing through the blanket connection to the electric blanket in accordance with the adjustment command control in light of the primary command controls.

4. The remote control system of claim 1, the remote control device further comprising a remote RF receiver coupled to the remote microcontroller and housed in the remote case, and the base unit further comprising a base RF transmitter coupled to the base microcontroller and housed in the base container;
wherein the remote RF receiver receives status information transmitted by the base RF transmitter, the remote RF receiver communicates the status information to the remote microcontroller, and the remote microcontroller presents a user-relevant portion of the status information on the digital display.

5. The remote control system of claim 1, wherein the remote power source includes a battery removably housed within the remote case and removably coupled to the remote power supply connection.

6. The remote control system of claim 1, wherein the base power source includes an electrical outlet, the power cord is removably coupled to the base power supply connection and removably couplable to the electrical outlet, and the base power supply connection includes an AC/DC converter coupled to the base microcontroller.

7. The remote control system of claim 1, the remote control device further comprising a remote antenna coupled to the remote RF transmitter, and the base unit further comprising a base antenna coupled to the base RF receiver.

8. The remote control system of claim 4, the remote control device further comprising a remote antenna coupled to the remote RF transmitter and to the remote RF receiver, and the base unit further comprising a base antenna coupled to the base RF receiver and to the base RF transmitter.

9. The remote control system of claim 1, wherein the remote microcontroller includes a remote central processing unit, remote read-only memory, remote random-access memory, a remote input port, a remote output port, and a display driver, the remote input port interfacing the keypad with the remote central processing unit, the remote output port interfacing the remote RE transmitter with the remote central processing unit, and the display driver interfacing the digital display with the remote central processing unit.

10. The remote control system of claim 1, the base unit further comprising
a variable control circuit coupled to the base microcontroller, to the base power supply connection, and to the blanket connection and housed in the base container, and
a safety detection circuit coupled to the base microcontroller and to the blanket connection and housed in the base container;
wherein the variable control circuit modulates an electric current received via the base power supply connection for transfer to the electric blanket via the blanket connection in accordance with instructions received from the base microcontroller, and the safety detection circuit monitors the electric current passing through the electric blanket and notifies the base microcontroller of blanket conditions.

11. The remote control system of claim 10 wherein the base microcontroller includes a base central processing unit, base read-only memory, base random-access memory, and a base input port, a base output port, the base input port interfacing the base RF transmitter and the safety detection circuit with the base central processing unit, the base output port interfacing the variable control circuit with the base central processing unit.

12. The remote control system of claim 4, the base unit further comprising a battery removably coupled to the base microcontroller and housed in the base container, wherein the base unit communicates the status information to the remote control device and the remote control device represents the user-relevant portion of the status information on the digital display even when the base power supply connection is not connected to the base power source and the blanket connection is not connected to the electric blanket.

13. The remote control system of claim 1, the base unit further comprising a LED indicator coupled to the base microcontroller and housed on the base container, wherein the LED indicator luminesces when the electric blanket is operating.

14. The remote control system of claim 1, the base unit further comprising a sound generator coupled to the base microcontroller and housed in the base container, wherein the sound generator makes an audible sound when the base unit receives a command control from the remote control device.

15. The remote control system of claim 1, wherein the keypad includes an LED keypad backlight coupled to the keypad and housed in the remote case, the digital display includes an LED display backlight coupled to the digital display and housed in the remote case, and the LED keypad backlight and the LED display backlight luminesce when the user uses the keypad.

16. A remotely controlled electric blanket system, the system comprising:
an electric blanket being electrically connectable to a power source;
a remote control device having a remote RF transceiver; and
a base unit having a base RF transceiver and being electrically connectable between the electric blanket and the power source;
wherein the remote RF transceiver transmits command controls to and receives status information from the base RF transceiver, whereupon the base unit modulates an electric current flowing from the power source and through the electric blanket in accordance with the command controls received from the remote control device.

17. A method of remotely controlling an electric blanket, the method comprising:
coupling a remote power supply connection of a remote control device to a remote power source,
coupling a base power supply connection of a base unit to a base power source,
coupling a blanket connection of the base unit to the electric blanket,
using a keypad on the RF remote control device to generate primary command controls, the primary command controls then being represented on a digital display on the remote control device and communicated to a remote microcontroller on the remote control device, the remote microcontroller interfacing the primary command controls with a remote RF transmitter on the remote control device, the remote RF transmitter transmitting the primary command controls to a base RF receiver on the base unit, the base RF receiver interfacing the primary command controls with a base microcontroller on the base unit, and the base microcontroller modulating an electric current flowing through the blanket connection to the electric blanket in accordance with the primary command controls received from the remote control device.

18. A method of remotely controlling an electric blanket, the method comprising:
using a keypad on a remote control device to generate primary command controls,
displaying the primary command controls on a digital display on the remote control device
communicating the primary control commands to a remote microcontroller on the remote control device,
interfacing the primary command controls with a remote RF transmitter on the remote control device,
transmitting the primary command controls to a base RF receiver on a base unit,
interfacing the primary command controls with a base microcontroller on the base unit, and
modulating an electric current flowing through a blanket connection on the base unit to the electric blanket in accordance with the primary command controls received from the remote control device.
